(19) United States
(12) Patent Application Publication
(10) Pub. No.: US 2012/0073515 A1
(43) Pub. Date: Mar. 29, 2012

(54) INTRATHECAL NEEDLE GUIDE APPARATUS

(75) Inventors: Jin M. Chung, Galveston, TX (US); Kyngsoon Chung, Galveston, TX (US); Hee Young Kim, Galveston, TX (US)

(73) Assignees: Advanced Bionics Corporation; BOARD OF REGENTS, THE UNIVERSITY OF TEXAS SYSTEM, Austin, TX (US)

(21) Appl. No.: 13/247,978

(22) Filed: Sep. 28, 2011

Related U.S. Application Data
(60) Provisional application No. 61/387,337, filed on Sep. 28, 2010.

(51) Int. Cl. A01K 15/04

(52) U.S. Cl. 119/756

(57) ABSTRACT

An apparatus for inserting a needle into an intrathecal space of small animals is disclosed, where the apparatus includes an animal positioning platform having a curved section, and a needle guide that rotates around the curved section, and to methods for using same.

### CROSS-REFERENCE TO RELATED APPLICATIONS

This application claims the benefit of U.S. Provisional Application No. 61/387,337 filed Sep. 28, 2010, which is incorporated by reference in its entirety due to operation of the closing paragraph of the specification.

### FIELD OF THE INVENTION

Embodiments of the present invention relate to an apparatus for easy and sure access to an intrathecal space by a needle in small animals including rodents. More particularly, embodiments of the apparatus include an animal positioning platform and an adjustable intrathecal needle guide and to methods for using same.

### BACKGROUND OF THE INVENTION

Administering intrathecal injections to small animals such as mice and rats is very challenging. Often, it may take several attempts to properly insert and position a needle. Empirically, only about 50% of insertions are initially successful. Since intrathecal injection is a common requirement in animal research and is a difficult procedure to learn, there is a need for a guide apparatus.

In U.S. Publication No. 2008-0262433, published Oct. 23, 2008, we previously disclosed an intrathecal injection guide apparatus including an animal conforming member with two opposing apertures and a guide tube.

There is still a need in the art for an alternative system, especially a system capable of spreading a portion of the spine of small animals for facilitating intrathecal access.

### SUMMARY OF THE INVENTION

In one aspect, a small animal intrathecal injection guide apparatus is provided, the apparatus comprising: an animal positioning platform including a curved section, at least one arm pivotally mounted on the platform, where the arm rotates around the curved section, a cross member attached to the distal end of the arm, and a first needle guide mounted to the cross member at an angle α to the arm.

In some aspects, the apparatus further comprises an incisor bar.

In some aspects, the apparatus has one arm with a cross member. In others, the apparatus has a pair of arms pivotally mounted on the platform, where the arms rotate in coordination around the curved section, and the cross member connects the distal ends of the arms.

In one aspect, the angle α is about 15° to about −15°, or about 0°.

In some aspects, the apparatus further comprises a second needle guide mounted to the cross member at a second angle β to the arm. In one aspect, angle β is about 35° to about 55°, or about 45°.

In one aspect, the curved section defines a circular arc having a focal point. In one aspect, the curved section defines 90° of a circular arc. In one aspect, the arm rotates about the focal point such that the distal end of the arm defines a trajectory concentric to the circular arc.

In one aspect, the arm or arms are radially extendable, e.g., telescoping.

In one aspect, the apparatus includes a locking mechanism to restrict or prohibit the rotation of the arm and/or the pivot of the cross member.

In one aspect, the cross member is pivotally mounted to the arm such that angle α is adjustable.

In one aspect, the apparatus can further include an anesthesia delivery assembly comprising: an anesthesia mask, a gas inlet, and a gas outlet.

In one aspect, the incisor bar, anesthesia mask, and/or anesthesia assembly can be optionally adjustable in terms of distance to the curved section.

In one aspect, the cross member, needle guide, and/or the anesthesia assembly are detachable from the platform.

In one aspect, the platform further comprises one or more marks to denote particular angles of injection.

In one aspect, the platform further comprises restraining walls extending vertically above the platform forming an animal restraining groove extending from the straight end to the curved end. The groove restrains an animal, placed in the groove to spread its spine, from moving laterally.

In one aspect, the needle guide is sized for needle gauge sizes between about 15 and about 35.

In another aspect, the invention provides a method for inserting a needle into an intrathecal space of a small animal comprising: positioning a small animal, belly or underside down, on the platform described herein so that a portion of the animal's spine conforms to the curved section, rotating the arm to aim the first needle guide toward an intrathecal space in the animal's spine, and inserting a needle through the first needle guide into the intrathecal space, e.g., between the L5 vertebra and L6 vertebra.

In one aspect, the needle is inserted at a trajectory that is substantially perpendicular to the tangent across the intrathecal space.

In another aspect, the method further includes the step of anesthetizing the animal before the positioning step, during the positioning step, and/or during the inserting step.

### BRIEF DESCRIPTION OF THE DRAWINGS

The invention can be better understood with reference to the following detailed description together with the appended illustrative drawings in which like elements are numbered the same, and the drawings are not necessarily to scale:

FIGS. 1A-C depict an exemplary single arm apparatus. FIG. 1A shows a side view where the arm is at an angle of 45°. FIG. 1B shows a top view where the arm is vertical. FIG. 1C shows a top view where the arm is horizontal.

FIGS. 1D-E depict an exemplary apparatus featuring a pair of arms. FIG. 1D shows a top view with the arms at a vertical position. FIG. 1E shows a top view with the arms at a horizontal position.

FIGS. 2A-C depict an exemplary apparatus featuring anon-slip surface. FIG. 2A shows a side view where the arms are at an angle of 45°. FIG. 2B shows a top view where the arms are vertical. FIG. 2C shows a top view where the arms are horizontal.

FIG. 3 depicts a side view of an embodiment of the apparatus featuring a locking mechanism to selectively fix the arm rotation at a particular angle θ.

FIGS. 4A-B depict top views of an exemplary apparatus featuring a cross member with a rotatable center section. In FIG. 4A, the arm is vertical; in FIG. 4B, the arm is horizontal.

FIG. 5 depicts another exemplary apparatus including two cannulas and an anesthesia assembly.

FIG. 6 depicts a side plan view of the small animal intrathecal injection guide apparatus of FIG. 5 with an animal situated on the apparatus.

FIG. 7 depicts a side plan view of the small animal intrathecal injection guide apparatus of FIG. 5 including a longitudinal groove with an animal situated on the apparatus.

### DETAILED DESCRIPTION OF THE INVENTION

The inventors have designed an apparatus to facilitate insertion of a needle into the intrathecal space of a small animal. The apparatus can be used for injecting agents (e.g., pharmaceutical agents, nutraceutical agents, biological agents, chemical agents, pathogens, and/or toxins) into, or for withdrawing spinal fluids from small animals, especially mice and rats. In some embodiments, the apparatus includes an animal positioning platform including a curved section, at least one arm pivotally mounted on the platform, where the arm rotates around the curved section, a cross member attached to the distal end of the arm, and at least one needle guide mounted to the cross member at an angle α to the arm.

Animal Positioning Platform

In some embodiments, the apparatus includes an animal positioning platform having a curved section. The curved section provides a surface upon which to conform the animal's spine, to round the spine into a convex conformation thereby spreading the vertebrae (e.g., broadening a dorsal intervertebral space) to facilitate intrathecal access. In some embodiment, the curved section curves downwardly such that gravity assists in conforming the animal's spine to the curved section. The curved section can be designed to conform to any section of the spine, including the cervical, thoracic, lumbar, sacral or coccygeal regions. In some embodiments, the curved section is designed so that an underside of a small animal conforms to the curved section to spread a space of lumbar vertebrae, especially the L5 and L6 vertebrae.

The curved section has a slope such that the animal's spine, when conformed to the curved section, has a more convex curvature compared to the animal's nature posture and/or a substantially horizontal axis. In some embodiments, the curved section defines a substantially circular arc. For example, the curved section may define a circular arc spanning about 40° to about 100°, about 45° to about 95°, about 60° to about 90°, or about 75° to about 90°. In one embodiment, the curved section defines about 90° of a circular arc. In this embodiment, the platform includes a horizontal section, a curved section, and a vertical section where the animal's body conforms in part to each of the three sections. For example, the head and/or neck region can conform to the horizontal section, the thoracic and/or lumbar region can conform to the curved section, and the hindquarters and/or tail can conform to the vertical section.

The platform can further include one or more marks to denote particular angles of injection. For example, the platform may feature lines, hashmarks, or other visual cues to provide the user a guide for rotating the arms to particular angles.

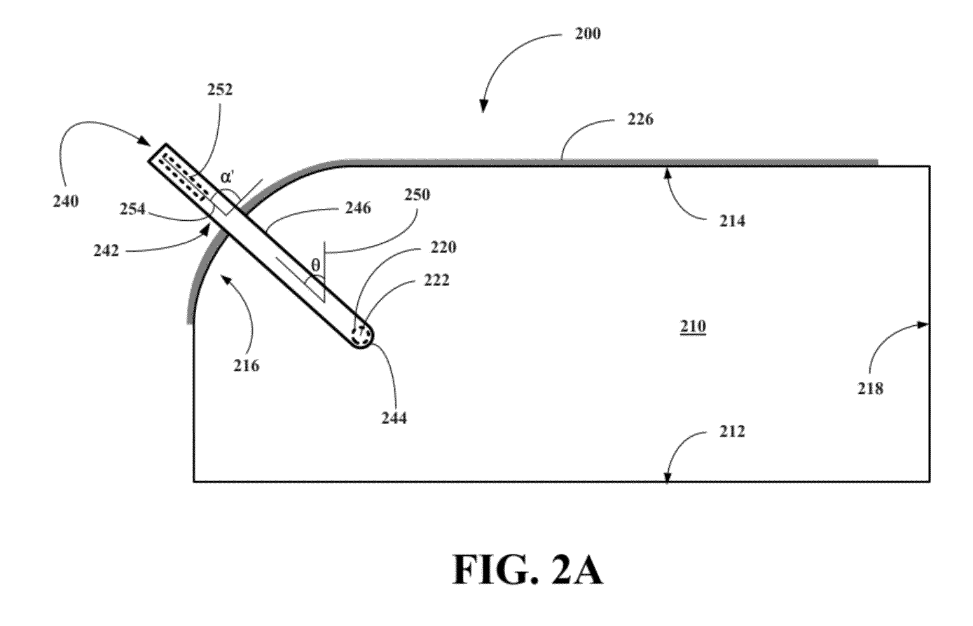

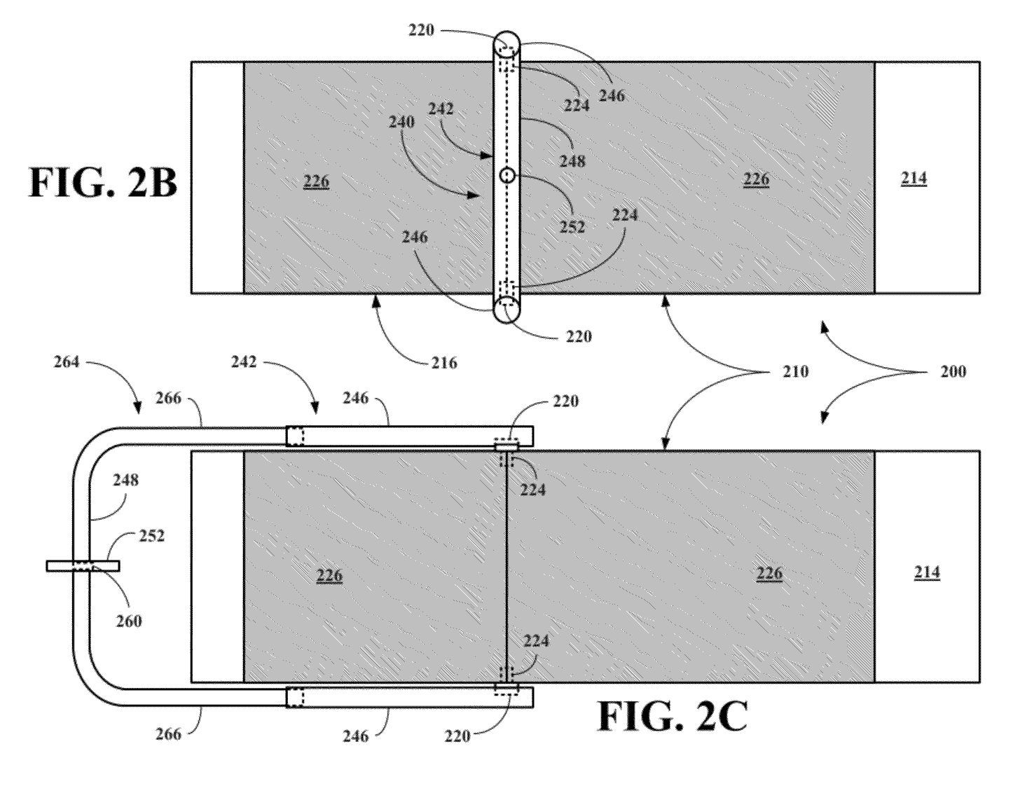

In some embodiments, the apparatus includes an animal restraint to inhibit or prohibit movement of the animal on the platform. The animal restraint can include, for example, one or more restraining walls on either side of the platform to prevent lateral movement, and straps or loops to secure the animal to the platform. The platform may also feature a non-skid surface on at least a portion of the platform to prevent the animal from sliding backwards by gravity on the hindquarters (see FIG. 2A), or it may include a smooth surface to facilitate positioning the animal as desired on the curved section and for ease of cleaning.

The apparatus can further include a base under the platform. The base may provide additional support and stabilization for the apparatus. Suitable materials for constructing the platform and base include, without limitation, structural plastics, foamed plastics, wood, metals, or mixtures and combinations thereof.

Rotating Arm

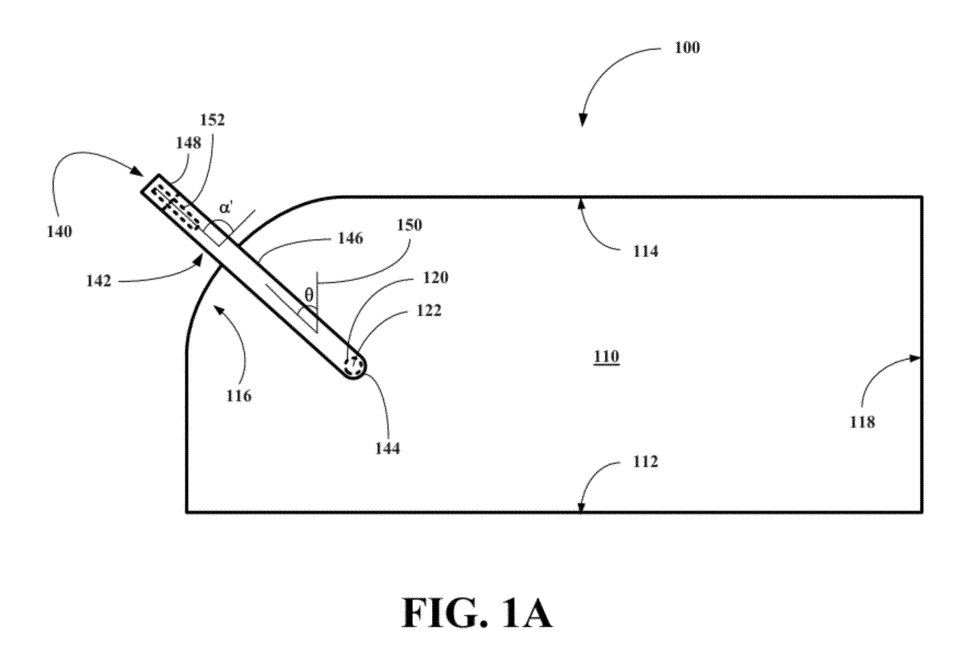

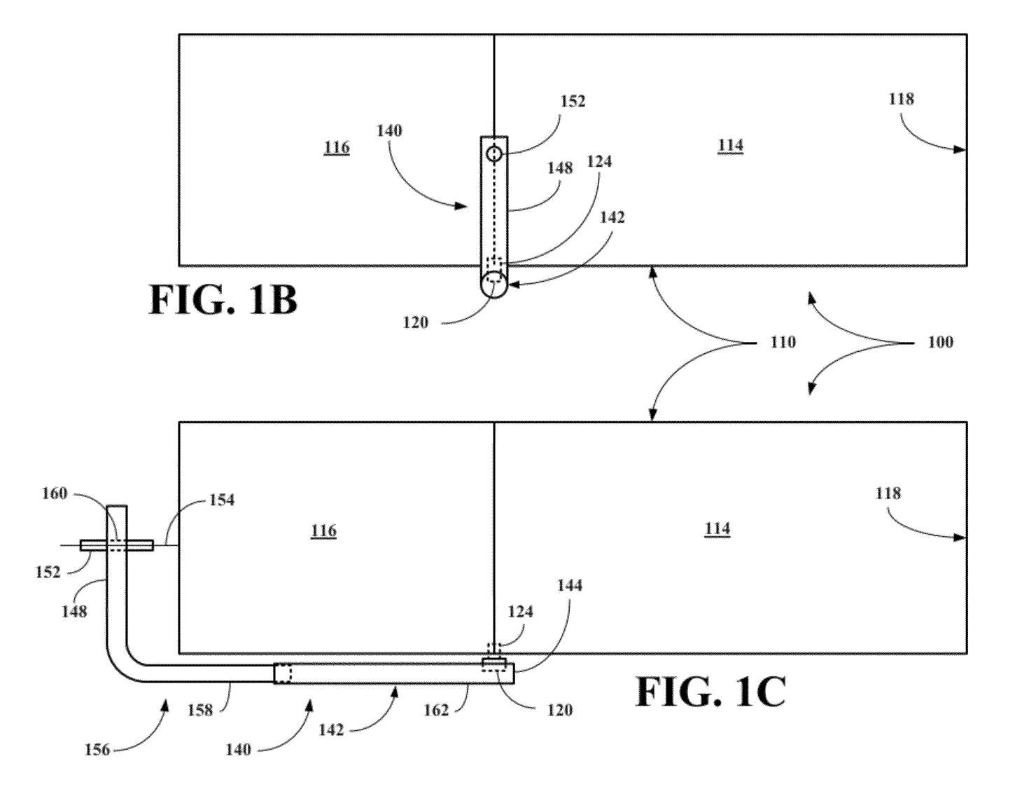

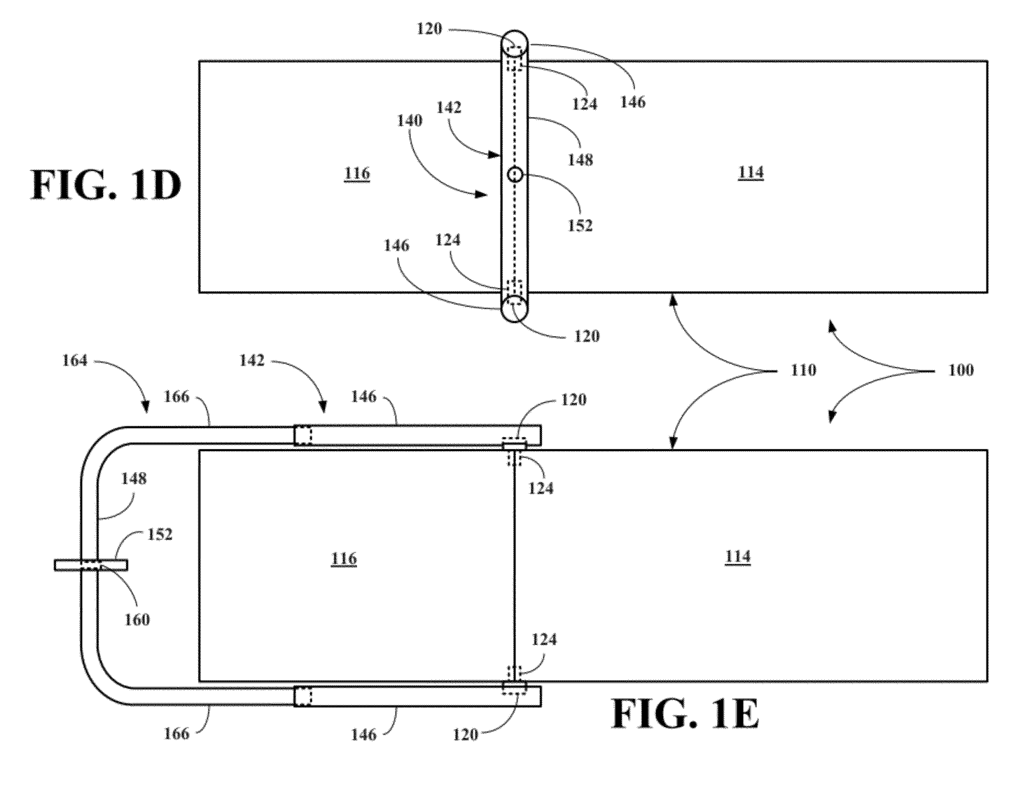

In some embodiments, the apparatus includes at least one arm pivotally mounted on the platform, where the arm rotates around the curved section. In some embodiments, the apparatus includes two arms each pivotally mounted on the platform, where the arms rotate around the curved section. Thus, in some embodiments, the arm and cross member together can be L-shaped or U-shaped. See, e.g., FIGS. 1C and 1E, respectively. The description below applies to both types of embodiments (i.e., single arm or pair of arms).

The angle of the arm relative to the vertical is defined by angle θ. Although the arm does not necessarily rotate around the entirety of the curved section, a wide range of motion facilitates versatility in injection angle. A wider range of motion may also allow for arm positions that are unobtrusive while positioning the animal. In some embodiments, the arm rotates over the entirety of the curved section. In some embodiments, the arm further rotates beyond the curved section, e.g., back toward a horizontal section of the platform or down toward a vertical section of the platform. The arms may have one or more resting positions, e.g., the arms can be rotated to rest on a horizontal section or a vertical section of the platform.

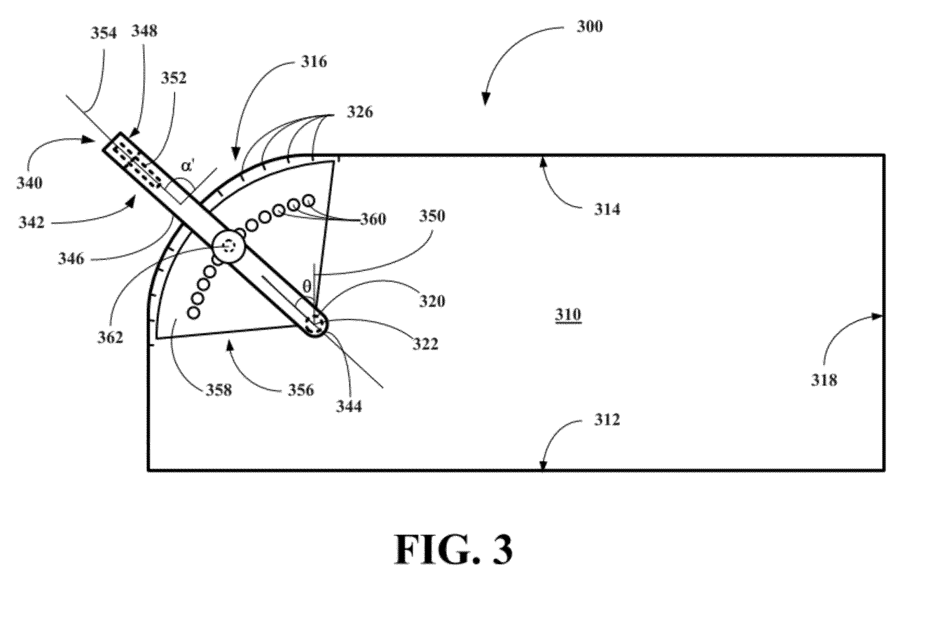

In some embodiments, the apparatus includes a locking mechanism to restrict or prohibit rotation of the arms. The arm rotation locking mechanism can be used to fix the arms at a desired position. See FIG. 3. In one embodiment, the arms can be locked at an angle θ that is about 35° to about 55°, or about 45° to the vertical. In another embodiment, the arms can be locked at a resting position.

In embodiments where the platform's curved section defines a circular arc, the arm can extend from the focal point of the platform's circular arc. In this way, the distal end of the arm can define a trajectory concentric to the platform's circular arc.

In embodiments having a pair of arms, the arms may rotate in coordination. Coordinated rotation of the arms can be achieved by attaching the proximal end of the arms to an axial member inserted into an aperture through the platform at a focal point of the curved section. Additionally or alternatively, coordinated rotation can be achieved by attaching a cross member to the distal ends of both arms.

In some embodiments, the arm is radially extendable. The extendable arm can comprise accordion-type extendable members, telescoping members, tongue and groove slidable members, spring pin slidable and lockable members, or other type of extendable members as is known in the mechanical arts. In one embodiment, the arm is telescoping. The arm can include an extension locking mechanism to restrict or prohibit extending or retracting the arms. In this way, the arms can be fixed at a desired length. For example, telescoping or tongue and groove slidable members may include O-rings to restrict or prohibit extension and/or retraction.

Cross Member

In some embodiments, the apparatus includes a cross member attached to the distal end of the arm. The distal end need not be the terminus of the arm. Rather, the cross member should be attached to the arm at a distal position sufficient to allow the cross member to rotate over the animal when placed on the curved surface. In some embodiments, the cross member is distally adjustable to allow for the different girth of various small animals. The cross member may be distally adjustable, for example, by the arm having various points of attachment for the cross member, or by having the cross member be distally slideable along the arm.

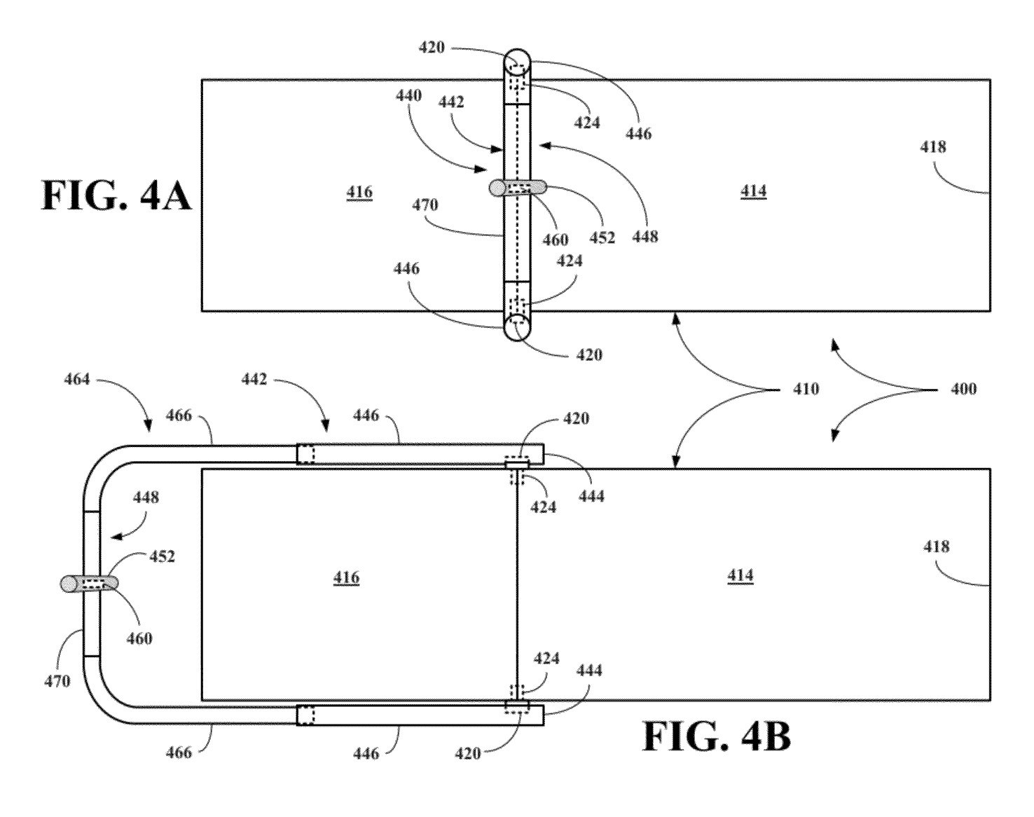

In some embodiments, the cross member is pivotally adjustable to provide additional versatility of injection angle. See, e.g., FIGS. 4A-B. In some embodiments, the cross member can pivot to any angle, e.g., it can fully rotate about an axis extending between the distal ends of two arms. Thus, in some embodiments, the angle of injection can be adjusted by rotating the arms and/or pivoting the cross member. The apparatus can further include a locking mechanism to restrict or prohibit the pivot of the cross member. The cross member locking mechanism can be used to fix the cross member at a desired angle relative to the arms, and in turn, to fix a desired angle of injection. The cross member can alternatively be fixed at desired angle relative to the arms by providing a non-pivotal, i.e. stationary, cross member.

In any case (e.g., a stationary cross member or a pivoting cross member), the cross member can be, e.g., at an angle of about −90° to about 90° relative to the arms. In some embodiments, the cross member can be at an angle of about −60° to about 60°, about −45° to about 45°, about 35° to about 55°, about −30° to about 30°, or about −15° to about 15° relative to the arms. In one embodiment, the cross member can be at an angle of about −15° to about 15° relative to the arms.

In one embodiment, the cross member can be at an angle of about 0° relative to the arms such that when the needle guide is parallel to the cross member, the angle of injection is the same as, or parallel to, the angle of the arms. In another embodiment, the cross member can be at an angle of about 35° to about 55°, or about 45° relative to the arms.

In some embodiments, the cross member is integrally formed with arm. The cross member can alternatively be permanently affixed to the arm (e.g., as by soldering). The cross member can alternatively be detachably affixed to the arm, e.g., by a snap-lock mechanism, a screw-type mechanism, or as part of the telescoping mechanism.

Needle Guide

Mounted to the cross member is at least one needle guide (e.g., cannula). The needle guide establishes the angle of injection. The needle guide angle can be, e.g., about −90° to about 90° relative to the arms. In some embodiments, the needle guide angle can be at an angle of about −60° to about 60°, about −45° to about 45°, about 35° to about 55°, about 40° to about 50°, about 45°, about −30° to about 30°, about −15° to about 15°, about −5° to about 5°, or about 0° relative to the arms. In one embodiment, the needle guide angle is about −15° to about 15°, or about 0° relative to the arms. In another embodiment, the needle guide angle is about 35° to about 55°, or about 45° relative to the arms. In certain embodiment, the needle guide is stationary with respect to the cross member.

In some embodiments, the apparatus includes two or more needle guides. A first needle guide makes an angle α with respect to the arm (or an angle α′=90−a relative an axis perpendicular to the arm). A second needle guide makes an angle β with respect to the arm (or an angle (′=90−b with respect to an axis perpendicular to the arm). Each needle guide angle with respect to the arms (e.g., α and β) can be selected independently. Angle α can be, e.g., about −15° to about 15°, about −5° to about 5°, or about −2.5° to about 2.5°. In some embodiments, angle α is about 0°. Angle β can be, e.g., about 35° to about 55°, about 40° to about 50°, or about 42.5° to about 47.5°. In some embodiments, angle β is about 45°. “First” and “second” are provided here as a naming convention only and are not meant to designate any particular order of attachment or insertion.

Each needle guide can be independently sized to accommodate particular needle gauge sizes. When the apparatus has two or more needle guides, the size of the needle guides can be the same as or different from one another. Exemplary needle gauge sizes appropriate for intrathecal injection include about 15 to about 35, about 20 to about 30, and about 25 to about 30. In one embodiment, the apparatus includes one or more needle guides sized for a needle gauge of about 25 to about 30.

In some embodiments, the needle guide can be detachable, disposable, and/or recyclable. Inexpensive or recyclable plastic or metal materials are known in the art for such construction. In another embodiment, the needle guide is permanently affixed to the cross member.

Incisor Bar

In one embodiment, the apparatus includes an incisor bar. The incisor bar can be a small rod mounted on a horizontal section of the platform, such that the animal's incisors are placed over the bar to position the animal's spine on the curved section.

The incisor bar can be adjustable in terms of distance from the curved section such that the apparatus can be used for small animals of various lengths and/or to adapt the apparatus for insertion of a needle into different portions of the animal's spine. Adjustability can be provided by known mechanical means such as by providing multiple alternative points of attachment for the incisor bar on the platform (e.g., on the platform's horizontal section) or by providing a slideable incisor bar.

Anesthesia Assembly

In some embodiments, the apparatus also includes an anesthesia delivery assembly to anesthesize the animal before placing the animal on the platform, during placement of the animal on the platform, and/or during needle insertion. The anesthesia delivery assembly can include a mask as well as a gas inlet and a gas outlet. The gas inlet can be connected (e.g., via anesthetic tubing as is known in the art) to a supply of anesthetic gas, oxygen, and/or air, while the gas outlet allows for removal of expiration gasses. Alternatively or additionally, the animal can be pre-anesthetized by any conventional means before placement on the platform.

The mask can surround an incisor bar as described above to facilitate placement of the mask on the animal.

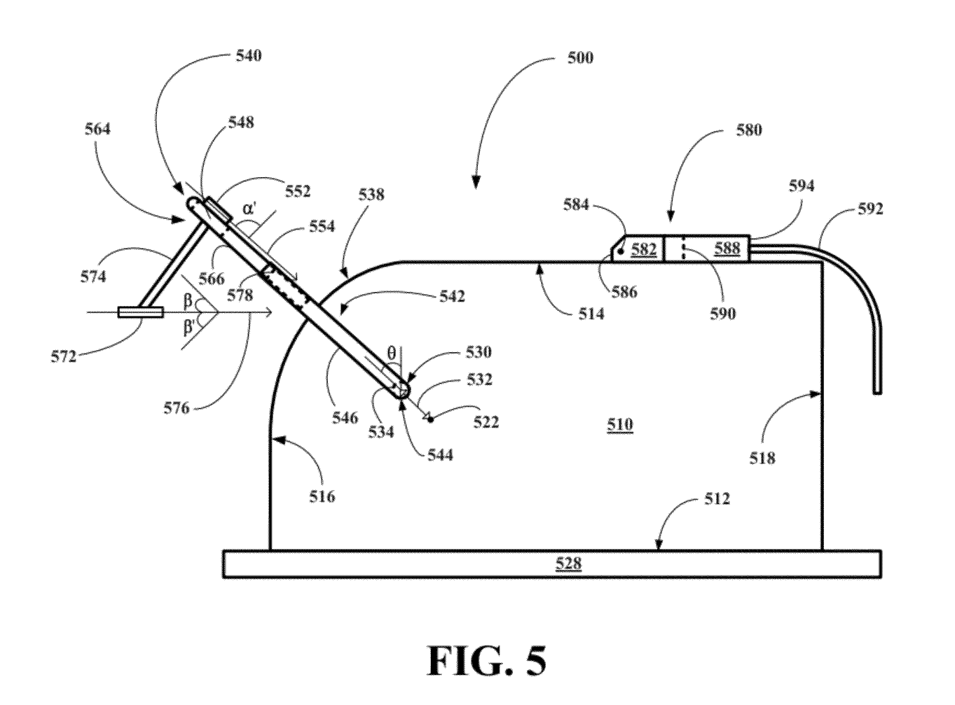

Like the incisor bar, the mask and/or the entire anesthesia delivery assembly can be adjustable, e.g., slideable, relative to the curved section. In some embodiments, the mask is adjustable toward or away from the curved section such that the apparatus can be used for small animals of various lengths and/or to adapt the apparatus for insertion of a needle into different portions of the animal's spine. The mask can be adjusted by sliding along the platform or by sliding within the anesthesia assembly (as shown in FIG. 5). In one embodiment, the incisor bar and the mask adjust together as a unit. In another embodiment, the incisor bar and the anesthesia delivery assembly adjust together as a unit.

In one embodiment, the anesthesia delivery assembly is detachable from the platform. This may advantageously provide a means for using a single anesthesia delivery system both before the animal is on the platform and while the animal is on the platform.

In some embodiments, the anesthesia mask and/or delivery assembly is detachable from the platform. In some embodiments, the anesthesia mask and/or delivery assembly is disposable or recyclable to increase hygienic compliance. Inexpensive or recyclable plastic or metal materials are known in the art for such construction.

Methods for Inserting a Needle into the Intrathecal Space

The invention also provides methods for inserting a needle into the intrathecal space of a small animal. The method comprises providing an apparatus as described in any of the embodiments above, positioning the small animal on the platform so that a portion of the animal's spine is conformed to the curved section, rotating the arm to aim a needle guide toward an intrathecal space in the animal's spine, and inserting a needle through a needle guide into the intrathecal space. The small animal is placed belly down on the platform. Small animals suitable for use with the apparatuses and methods described herein include mammals that are less than 3000 g, preferably less than 2000 g, 1000 g, 700 g, 500 g, 100 g, 50 g, 40 g, 30 g, 20 g, or 10 g. In some embodiments, the small animal is a mammal of about 5 g to about 50 g, about 7 to about 30 g, or about 10 g to about 20 g. Exemplary small animals include, but are not limited to: mice, rats, guinea pigs, rabbits, hamsters, gerbils, and ferrets. Preferably, the small animal is a rodent, i.e., a mammal in the order Rodentia. In one embodiment, the small animal is a mouse or rat.

The method can further include anesthetizing the animal before placement on the platform, during the positioning step, and/or during the inserting step. At any of these stages, the anesthesia can be delivered via the anesthesia delivery assembly as described above. When anesthesia is administered before placement on the platform, anesthesia can additionally or alternatively be delivered by conventional techniques known in the art such as placing the animal in an anesthetic chamber containing an anesthetic gas. In one embodiment, the animal is at least partially anesthetized before placement on the platform. In one embodiment, anesthesia is continuously administered during the positioning and inserting step.

In one embodiment, positioning the animal on the platform comprises placing the animal's incisor's over an incisor bar.

In embodiments where an incisor bar and/or anesthesia mask is adjustable relative to the curved section, positioning the animal can include adjusting the incisor bar and or anesthesia mask toward or away from the curved section to conform the animal's spine, preferably the lumbar region, over the curved section.

Positioning the animal on the platform includes conforming a portion of the animal's spine to the curved section of the platform. The conformed spine portion can be, e.g., the cervical, thoracic, lumbar, sacral or coccygeal region of the spine. Preferably, the animal is positioned such that the curved section conforms the lumbar vertebrae, especially the L5 and L6 vertebrae.

The targeted intrathecal space can be between vertebrae (e.g., between the spinous processes of vertebrae) in the cervical, thoracic, lumbar, sacral or coccygeal region of the spine. In one embodiment, the targeted intrathecal space is in the lumbar region. The targeted intrathecal space can be the space on either side of any lumbar vertebra. In one embodiment, the targeted intrathecal space is the space between vertebrae L5 and L6.

For the insertion step, a needle is inserted into a needle guide, e.g., a cannula. Then, the needle can be pushed to penetrate skin, muscles, ligamentum flavum, and/or meninges (dura and arachnoid maters), and finally into the intrathecal (e.g., subarachnoid) space. A sudden release of the pressure of needle insertion and a sudden movement of animal's tail indicates that the needle is in the intrathecal space. After insertion into the intrathecal space, the method can include injecting a substance into the intrathecal space or withdrawing a substance from the intrathecal space.

In some embodiments, the method includes a step of rotating the arm to aim a needle guide toward an intrathecal space in the animal's spine. In some embodiments where the arms are distally extendable, e.g., telescoping, the method can further comprise extending or retracting the arms. In this way, the cross member and needle guide can be brought near to, or into contact with, the targeted intrathecal space. The method can further include locking the length of the arms and/or locking the rotation of the arms.

In some embodiments, the method includes a step of pivoting the cross member to aim a needle guide toward an intrathecal space in the animal's spine. The method can further include locking the cross member at a desired angle of injection.

The angle of insertion is defined by the rotation of the arms, the optional pivot of the cross member, and the angle of the needle guide relative to the arms. Using any or all of these features, the angle of insertion can be adjusted. In one embodiment, the angle of insertion is substantially perpendicular to the tangent across the intrathecal space. In other words, the needle can be perpendicular to a line drawn between the spinous processes of the vertebrae spanning the targeted intrathecal space.

### DETAILED DESCRIPTION OF THE DRAWINGS

Referring now to FIGS. 1A-C, an embodiment of an apparatus of the present invention, generally 100, is shown to include an animal positioning platform 110 and a guide unit or assembly 140. The animal positioning platform 110 includes a bottom 112, a top 114, a curved section 116, a straight end 118, and a guide mount 120. The mount 120 can be positioned at, near, or offset from a focal point 122 of the curved section 116. The mount 120 is shown here located at the focal point 122 of the curved section 116. The mount 120 includes an axial member or post 124 within the platform 110. FIG. 1A shows a side view of the apparatus 100 with the guide assembly 140 at an angle θ of 45° to the vertical. FIG. 1B shows a first top view with the guide assembly 140 in a vertical disposition, i.e., where angle θ is 0°. FIG. 1C shows a second top view with the guide assembly 140 in a horizontal disposition, i.e., where angle θ is 90°. In FIG. 1B, the post 124 is the same size as the mount 120, while in FIG. 1C, the post 124 is smaller than the mount 120. The guide unit or assembly 140 is pivotally mounted on the platform 110 via the mount 120. The guide assembly 140 includes an arm 142 having a proximal end 144 mounted on the mount 120, a straight radial portion 146, and a cross member 148. The arm 142 in this embodiment is in the shape of an L. The cross member 148 is the portion of the L that is perpendicular to, or makes an angle with, the straight radial portion 146 of the arm to cross over the curved section 116. The arm 142 is rotatable about the mount 120, and the arm's position is defined with respect to angle θ relative to a vertical axis 150. The arm 142 may be of a one piece construction, a two piece construction, or a three piece construction. Mounted on the cross member 148 is a first needle guide 152. In this embodiment, the needle guide 152 passes through the cross member 148 and makes an angle α with respect to the straight portion 146 of the arm 142 or an angle α′ perpendicular to the straight portion 146 of the arm 142. In certain embodiments, the angle α is about 0° or the angle α′ is about 90° where a needle trajectory 154 coincides with the angle α.

Looking at FIG. 1C, the arm 142 is L-shaped including a straight member 146 and an L-shaped member 156 including a radially straight portion 158 slidingly engaging the straight member 146 and the cross member 148 perpendicular to the straight portion 158 so that the arm 142 is adjustable to accommodate different animal sizes. FIG. 1C also shows the needle guide 152 mounted on the cross member 148 via a needle mount 160 defining the needle trajectory 154.

Looking at FIGS. 1D-E, the arm 142 is U-shaped. In FIG. 1D, the arm 142 is fixed or non-adjustable, while in FIG. 1E, the arm 142 includes two straight members 146 and a U-shaped member 164 including two straight portions 166 for slidingly engaging the straight members 146 so that the arm 142 is adjustable to accommodate different animal sizes. The cross member 148 comprises the bottom of the U shape. In FIG. 1D, the needle guide 152 is shown mounted through the cross member 148, while in FIG. 1E, the needle guide 152 is mounted on the cross-member 148 via a needle guide mount 160.

Referring now to FIGS. 2A-C, an embodiment of an apparatus of the present invention, generally 200, is shown to include an animal positioning platform 210 and an intrathecal injection guide unit or assembly 240. The animal positioning platform 210 includes a bottom 212, a top 214, a curved section 216, a straight end 218, and a guide assembly mount 220. The mount 220 can be positioned at, near, or offset from a focal point 222 of the curved section 216. The mount 220 is shown here located at the focal point 222 of the curved section 216. The mount 220 includes a post 224 resting within the platform 210. The platform 210 further includes a non-slip surface coating 226. The coating 226 may be a rubber coating or other type of coating that reduces the ability for an animal to slip from the curve section 216. FIG. 2A shows a side view of the apparatus 200 with the guide assembly 240 at an angle θ of 45° to the vertical. FIG. 2B shows a first top view with the assembly 240 in a vertical disposition, i.e., where angle θ is 0°. FIG. 2C shows a second top view with the assembly 240 in a horizontal disposition, i.e., where angle θ is 90°. In FIG. 2B, the post 224 is the same size as the mount 220, while in FIG. 2C, the post 224 is smaller than the mount 220.

The intrathecal injection guide unit or assembly 240 is pivotally mounted on the platform 210 via the mount 220. The assembly 240 includes an arm 242 having a proximal end 244 mounted on the mount 220, a straight radial portion 246, and cross member 248, where the arm 242, in this embodiment, is in the shape of an L and the cross member 248 is the portion of the L that is perpendicular to, or makes an angle with, the straight radial portion 246 of the arm. The arm 242 is rotatable about the mount 220 with its position defined with respect to angle θ relative to a vertical axis 250. The arm 242 may be of a one piece construction, a two piece construction, or a three piece construction. Mounted in the cross member 248 is a first needle guide 252. In this embodiment, the needle guide 252 passes through the cross member 248 and makes an angle α with respect to the straight portion 246 of the arm 242 or an angle α′ perpendicular to the straight portion 246 of the arm 242. In certain embodiments, the angle α has a value of 0° or the angle α′ is 90° where a needle trajectory 254 coincides with the angle α.

Looking at FIGS. 2B-C, the arm 242 is U-shaped. In FIG. 2B, the arm 142 is fixed or non-adjustable, while in FIG. 2C, the arm 242 includes two straight members 246 and a U-shaped member 264 including two straight portions 266 for slidingly engaging the straight members 246 so that the arm 242 is adjustable to accommodate different animal sizes. The cross-member 248 comprises the bottom of the U shape. In FIG. 2B, the needle guide 252 is shown mounted through the cross member 248, while in FIG. 2C, the needle guide 252 is mounted on the cross-member 248 via a needle guide mount 260.

Referring now to FIG. 3, an embodiment of an apparatus of the present invention, generally 300, is shown to include an animal positioning platform 310 and an intrathecal injection guide unit or assembly 340. The animal positioning platform 310 includes a bottom 312, a top 314, a curved section 316, a straight end 318, and a guide assembly mount 320. The mount 320 can be positioned at, near, or offset from a focal point 322 of the curved section 316. The mount 320 is shown here located at the focal point 322 of the curved section 316. The mount 320 includes a post (not shown) within the platform 310. The platform 310 also includes angle value indicators 326, here indicating intervals of about 12.5°.

The intrathecal injection guide unit or assembly 340 is pivotally mounted on the platform 310 via the mount 320. The guide assembly 340 includes an arm 342 having a proximal end 344 mounted on the mount 320, a straight radial portion 346, and a cross member 348, where the arm 342, in this embodiment, is in the shape of an L. The cross member 348 is the portion of the L that is perpendicular to, or that makes an angle with, the radial portion 346 of the arm. The arm 342 is rotatable about the mount 320, and the arm's position is described as angle θ relative to a vertical axis 350. The arm 342 may be of a one piece construction, a two piece construction, or a three piece construction. Mounted on the cross member 348 is a first needle guide 352 that passes through the cross member 348 and makes an angle α with respect to the straight portion 346 of the arm 342 or an angle α′ perpendicular to the straight portion 346 of the arm 342. In certain embodiments, the angle α is 0° or the angle α′ is 90° where a needle trajectory 354 coincides with the angle α.

The guide assembly 340 also includes a locking mechanism 356 including a plate 358 having a plurality of holes 360 therein. The straight member 346 of the arm 342 includes a spring loaded locking pin 362, where pulling up on the pin 362 allows the guide assembly 340 to be rotated and releasing the pin 362 allows the guide assembly 340 to be locked in place. While a spring loaded pin locking system is shown here, the guide assembly 340 may be locked into place by any other locking mechanism including a means to tighten around the mount 320, or a spring loaded pin with a rubberized foot, or any other type of locking mechanism capable of holding the guide assembly 340 at a given angle θ.

Referring now to FIGS. 4A-B, an embodiment of an apparatus of the present invention, generally 400, is shown to include an animal positioning platform 410 and an intrathecal injection guide assembly 440. The animal positioning platform 410 includes a bottom (not shown), a top 414, a curved section 416, a straight end 418, and a guide assembly mount 420. The mount 420 can be positioned at, near, or offset from a focal point (not shown) of the curved end 416. The mount 420 includes a post 424 within the platform 410.

The intrathecal injection guide unit or assembly 440 is pivotally mounted on the platform 410 via the mount 420. The assembly 440 includes an arm 442 having proximal ends 444 mounted on the mount 420. The arm 442 includes two radial members 446 and a U-shaped member 464. In FIG. 4A, the U-shaped member 464 is fixed and non-extendable. In FIG. 4B, the U-shaped member 464 is radially extendable and includes two straight portions 466 for slidingly engaging the radial members 446 and the bottom of the U-shape member 464 comprises a cross member 448. The arm 442 is rotatable about the mount 420 with its position defined with respect to the angle θ (not shown) to adjust the needle trajectory. The arm 442 is radially adjustable by sliding the straight portions 466 within the straight members 446 to accommodate different animal sizes. The arm 442 may be of a one piece construction, a two piece construction, or a three piece construction. The cross member 448 includes a rotatable central section 470. Mounted on the rotatable central section 470 is a needle guide 452, mounted on the cross member 448 via a needle mount 468. The rotatable central section 470 permits the angle α to be between −90° and +90°.

Referring now to FIG. 5, an embodiment of an apparatus of the present invention, generally 500, is shown to include an animal positioning platform 510. The apparatus 500 also includes an adjustable cannula support assembly 540 and an anesthesia assembly 580.

The animal positioning platform 510 includes a bottom 512, a top 514, a curved end 516 and a straight end 518. The platform 510 is mounted on an optional base 528. The platform 510 also includes an aperture 530 therethrough centered at an offset 532 from a focal point 522 of the curved end 516. The platform 510 also includes an axial shaft 534 mounted in the aperture 530.

The guide assembly 540 is pivotally mounted on the platform 510 via an axial shaft 534 inserted through the aperture 530 through the platform 510. The guide assembly 540 also includes an adjustable arm 542 having proximal ends 544 mounted on the axial shaft 534. The arm 542 includes two radial members 546 and a U-shaped member 564. The U-shaped member 564 includes two straight portions 566 for slidingly engaging the radial members 546 and the bottom of the U-shape member 564 comprises the cross member 548. The arm 542 is rotatable about the axial shaft 536 with its position defined with respect to the angle θ to adjust the needle trajectory. The arm 542 is radially adjustable by sliding the straight portions 566 within the straight members 546 to accommodate different animal sizes. The arm 542 may be of a one piece construction, a two piece construction, or a three piece construction.

Mounted on the cross member 548 is a first cannula or needle guide 552 disposed to provide a first needle trajectory 554, which makes an angle α with the arms 542 or an angle α′ with respect to an axis perpendicular to the arms 542, shown here in one embodiment, where the first trajectory 554 is parallel to the arms 542 or the angle α has a value of 0° or α′ has a value of 90°. The cross member 548 also includes a second cannula or needle guide 572 offset from the cross member 548 by a support member 574 and disposed to provide a second needle trajectory 576 at an angle β with respect to the arms, shown here in one embodiment, where the second trajectory 576 makes an angle of 45° to the arms or the angle β has the value of 45°. The guide assembly 540 is adjustable in two directions: rotationally about the axial shaft 534 and radially due to the telescoping nature of the arm 542. The straight portions 566 may include stop 578 so that the second portions 566 cannot be removed from the straight members 546. The straight members 546 may also include a release assembly (not shown) so that the straight portions 566, the cross member 548, and the cannulas 552 and 572 can be removed.

The platform 510 also includes an anesthesia assembly 580. The anesthesia assembly 580 includes an adjustable mask 582, that is adjustable in distance from the curved end 516. The mask 582 includes an incisor bar 584 at its proximal end 586. The anesthesia assembly 580 also includes a gas chamber 588 in which a distal end 590 of the mask 582 is disposed. The distal end 590 of the mask 582 slidingly engages the gas chamber 588 so that the incisor bar 584 may be positioned to accommodate animals of different sizes. The anesthesia assembly 580 includes a gas supply tube 592 connecting a distal end 594 of the gas chamber 588 to a gas supply (not shown). The gas is used to anesthetize the animal positioned on the platform 510. The curved end 516 includes a lumbar spreading surface 536 upon which a belly of a small animal is positioned so that the lumbar region of the animal's spine at a region including the L5 and L6 lumbar vertebrae is spread.

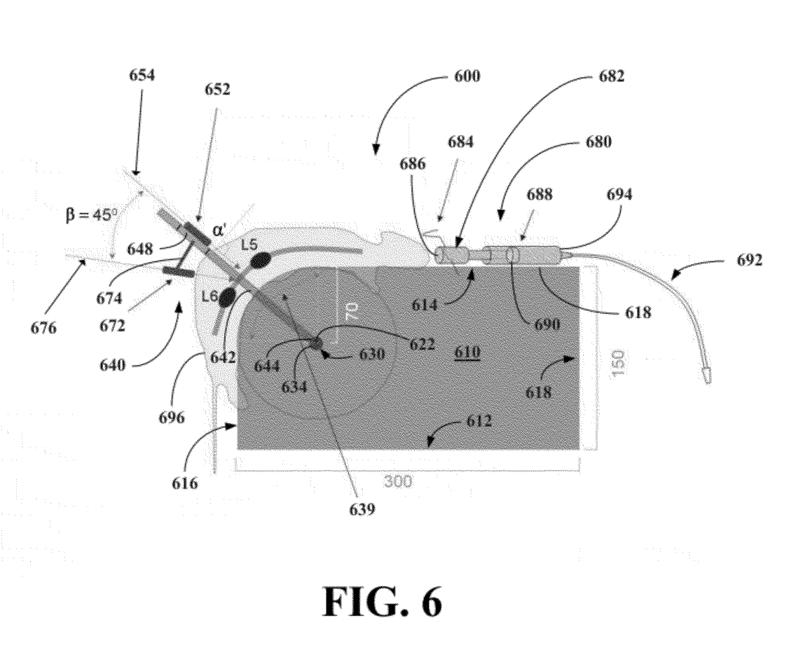

Referring now to FIG. 6, another embodiment of an apparatus of the present invention, generally 600, is shown to include an animal positioning platform 610. The apparatus 600 also includes an adjustable cannula support assembly 640 and an anesthesia assembly 680.

The animal positioning platform 610 includes a bottom 612, a top 614, a curved end 616 and a straight end 618. The platform 610 also includes an aperture 630 therethrough centered a focal point 622 of the curved end 616. The platform 610 also includes an axial shaft 634 mounted in the aperture 630.

The guide assembly 640 is pivotally mounted on the platform 610 via an axial shaft 634 inserted through the aperture 630 through the platform 610. The guide assembly 640 also includes an arm 642 having proximal ends 644 mounted on the axial shaft 634. The arm 642 includes a cross member 648. The arm 642 is rotatable about the axial shaft 634 with its position defined with respect to the angle θ (not shown) to adjust the needle trajectory. The arm 642 may be of a one piece construction, a two piece construction, or a three piece construction.

Mounted on the cross member 648 is a first cannula or needle guide 652 disposed to provide a first needle trajectory 654, which makes an angle α with the arms 642 or an angle α′ with respect to an axis perpendicular to the arms 642, shown here in one embodiment, where the first trajectory 654 is parallel to the arms 642 or the angle α has a value of 0° or α′ has a value of 90°. The cross member 648 also includes a second cannula or needle guide 672 offset from the cross member 652 by a support member 674 and disposed to provide a second needle trajectory 676 at an angle β with respect to the arms, shown here in one embodiment, where the second trajectory 676 makes an angle of 45° to the arms or the angle β has the value of 45°.

The platform 610 also includes an anesthesia assembly 680. The anesthesia assembly 680 includes an adjustable mask 682, that is adjustable in distance from the curved end 616, and having an incisor bar 684 at its proximal end 686. The anesthesia assembly 680 also includes a gas chamber 688 at its distal end 690 in which a distal end 690 of the mask 682 is disposed. The distal end 690 of the mask 682 slidingly engages the gas chamber 688 so that the incisor bar 684 may be positioned to accommodate animals of different sizes. The anesthesia assembly 680 includes a gas supply tube 692 connecting a distal end 694 of the gas chamber 688 to a gas supply (not shown). The gas is used to anesthetize the animal positioned on the platform 610. The curved end 616 includes a lumbar spreading surface 639 upon which a belly of a small animal is positioned so that the lumbar region of the animal's spine at a region including the L5 and L6 lumbar vertebrae is spread.

The guide unit 640 is mounted through an aperture 630 located about 70 mm from the top 614 and the curved end 616 of the platform 610. The first cannula 652 is disposed so that the angle α′ has a value of 90°, where the first injection trajectory 654 relative to a tangent across intrathecal space and the second cannula 672 is disposed so that the angle β is 45°, where the second injection trajectory is at this angle relative to tangent across intrathecal space. The apparatus 600 is shown with a small animal 696 positioned on the platform 610 with its spine stretched over the lumbar placing area 639 exposing the area between the L5 and L6 lumbar vertebrae. The platform 610 is shown here to have a length of about 300 mm and a height of about 150 mm. Of course, the dimensions will depend on the type of animals involved and are only meant as examples of an embodiment of the apparatuses of this invention. For example, the apparatus could be sized specifically for a typical laboratory rat or specifically for a typical laboratory mouse.

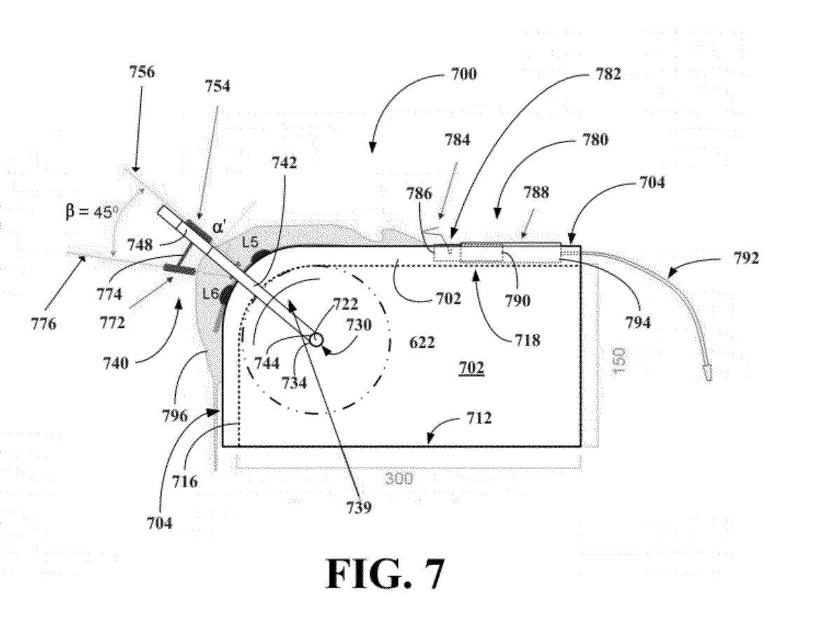

Referring now to FIG. 7, another embodiment of an apparatus of the present invention, generally 700, is shown to include an animal positioning platform 710. The apparatus 700 also includes an adjustable cannula support assembly 740 and an anesthesia assembly 780.

The animal positioning platform 710 includes a bottom 712, a top 714, a curved end 716 and a straight end 718. The platform 710 also includes an aperture 730 therethrough centered a focal point 722 of the curved end 716. The platform 710 also includes an axial shaft 734 mounted in the aperture 730. The platform 710 also includes restraining walls 702 forming an animal restraining groove 704. The groove 704 is configured so that the animal is stabilized from moving laterally after being positioned on the platform 710 within the groove 704.

The guide assembly 740 is pivotally mounted on the platform 710 via an axial shaft 734 inserted through the aperture 730 through the platform 710. The guide assembly 740 also includes an arm 742 having proximal ends 744 mounted on the axial shaft 734. The arm 742 includes a cross member 748. The arm 742 is rotatable about the axial shaft 734 with its position defined with respect to the angle θ (not shown) to adjust the needle trajectory. The arm 742 may be of a one piece construction, a two piece construction, or a three piece construction.

Mounted on the cross member 748 is a first cannula or needle guide 752 disposed to provide a first needle trajectory 754, which makes an angle α with the arms 742 or an angle α′ with respect to an axis perpendicular to the arms 742, shown here in one embodiment, where the first trajectory 754 is parallel to the arms 742 or the angle α has a value of 0° or α′ has a value of 90°. The cross member 748 also includes a second cannula or needle guide 772 offset from the cross member 748 by a support member 774 and disposed to provide a second needle trajectory 776 at an angle β with respect to the arms, shown here in one embodiment, where the second trajectory 776 makes an angle of 45° to the arms or the angle β has the value of 45°.

The platform 710 also includes an anesthesia assembly 780. The anesthesia assembly 780 includes an adjustable mask 782, that is adjustable in distance from the curved end 716, and having an incisor bar 784 at its proximal end 786 The anesthesia assembly 780 also includes a gas chamber 788 at its distal end 790 in which a distal end 790 of the mask 782 is disposed. The distal end 790 of the mask 782 slidingly engages the gas chamber 788 so that the incisor bar 784 may be positioned to accommodate animals of different sizes. The anesthesia assembly 780 includes a gas supply tube 792 connecting a distal end 794 of the gas chamber 788 to a gas supply (not shown). The gas is used to anesthetize the animal positioned on the platform 710. The curved end 716 includes a lumbar spreading surface 739 upon which a belly of a small animal is positioned so that the lumbar region of the animal's spine at a region including the L5 and L6 lumbar vertebrae is spread.

The guide unit 740 is mounted on the axial member 736 about 70 mm from a top 714 and curved end 716 of the platform 710. The first cannula 754 is disposed so that the angle α′ has a value of 90°, where the first injection trajectory 756 relative to a tangent across intrathecal space and the second cannula 758 is disposed so that the angle β is 45°, where the second injection trajectory is at this angle relative to tangent across intrathecal space. The apparatus 600 is shown with a small animal 796 positioned on the platform 710 with its spine stretched over the lumbar placing area 739 exposing the area between the L5 and L6 lumbar vertebrae. The platform 610 is shown here to have a length of about 300 mm and a height of about 150 mm. Of course, the dimensions will depend on the type of animals involved and are only meant as examples of an embodiment of the apparatuses of this invention. For example, the apparatus could be sized specifically for a typical laboratory rat or specifically for a typical laboratory mouse.

Closing Paragraph

All references cited herein are incorporated by reference. Although the invention has been disclosed with reference to its preferred embodiments, from reading this description those of ordinary skill in the art may appreciate changes and modification that may be made that do not depart from the scope and spirit of the invention as described above and claimed hereafter.

We claim:

1. A small animal intrathecal injection guide apparatus comprising:
an animal positioning platform including a curved section,
at least one arm pivotally mounted on the platform, where the arm rotates around the curved section,
a cross member attached to the distal end of the arm, and
a first needle guide mounted to the cross member at an angle α to the arm.

2. The apparatus of claim 1, further comprising an incisor bar.

3. The apparatus of claim 2, wherein the incisor bar is adjustable relative to the curved surface.

4. The apparatus of claim 1, further comprising a pair of arms pivotally mounted on the platform, where the arms rotate in coordination around the curved section, and the cross member connects the distal ends of the arms.

5. The apparatus of claim 1, wherein the angle α is about 15° to about −15°.

6. The apparatus of claim 5, wherein the angle α is 0°.

7. The apparatus of claim 1, further comprising a second needle guide mounted to the cross member at a second angle β to the arm.

8. The apparatus of claim 7, wherein the angle β is about 35° to about 55°.

9. The apparatus of claim 8, wherein the angle β is 45°.

10. The apparatus of claim 1, wherein the curved section defines 90° of a circular arc.

11. The apparatus of claim 1, wherein the curved section defines a circular arc having a focal point, and the arm rotates about the focal point such that the distal end of the arm defines a trajectory concentric to the circular arc.

12. The apparatus of claim 1, wherein the arm is radially extendable.

13. The apparatus of claim 1, further comprising a locking mechanism that restricts rotation of the arm.

14. The apparatus of claim 1, wherein the cross member is detachable from the arm.

15. The apparatus of claim 1, wherein the cross member is pivotally mounted to the arm such that angle α is adjustable.

16. The apparatus of claim 15, further comprising a locking mechanism that restricts the pivot of the cross member.

17. The apparatus of claim 1, wherein the platform further comprises one or more marks to denote particular angles of injection.

18. The apparatus of claim 1, wherein the needle guide is sized for a needle size of about 15 to about 35 gauge.

19. The apparatus of claim 1, further comprising an anesthesia delivery assembly comprising:
an anesthesia mask surrounding the incisor bar,
a gas inlet, and
a gas outlet.

20. The apparatus of claim 19, wherein the anesthesia delivery assembly is detachable from the platform.

21. A method for inserting a needle into an intrathecal space of a small animal comprising:
providing the apparatus of claim 1,
positioning the small animal on the platform so that a portion of the animal's spine is conformed to the curved section,
rotating the arm to aim the first needle guide toward an intrathecal space in the animal's spine, and
inserting a needle through the first needle guide into the intrathecal space.

22. The method of claim 21, where the intrathecal space is between the L5 vertebra and L6 vertebra.

23. The method of claim 21, wherein the first needle guide is aimed substantially perpendicular to the tangent across the intrathecal space.

24. The method of claim 21, further comprising anesthetizing the animal before the positioning step, during the positioning step, and/or during the inserting step.
